(19) United States
(12) Patent Application Publication
(10) Pub. No.: US 2019/0167522 A1
(43) Pub. Date: Jun. 6, 2019

(54) CONTAINER FOR FLEXIBLE BAG COMPRISING TWO WORKING POSITIONS

(71) Applicant: SARTORIUS STEDIM FMT SAS, Aubagne (FR)

(72) Inventor: Frédéric BAZIN, Cassis (FR)

(73) Assignee: SARTORIUS STEDIM FMT SAS, Aubagne (FR)

(21) Appl. No.: 16/324,380

(22) PCT Filed: Jul. 12, 2017
(86) PCT No.: PCT/FR2017/000142

§ 371 Date: Feb. 8, 2019

(30) Foreign Application Priority Data
Aug. 23, 2016 (FR) 1670465

(51) Int. Cl. A61J 1/16; B01L 3/00; B01L 9/00; B65D 77/06

(52) U.S. Cl. CPC A61J 1/16; B01L 3/523; A61J 1/10; B65D 77/06; B01L 9/00

(57) ABSTRACT

The container for a flexible bag intended to contain a biopharmaceutical fluid, includes a lower wall, two lateral walls and a transfer wall making an obtuse angle with the lower wall, so that the container is able to occupy a first position of stable equilibrium and a second position in which the transfer wall is at right angles to the vertical direction. The container is configured to pass from the first position into the second position, and vice versa, by rotation about an edge corner connecting the lower wall and the transfer wall, and is able to hold itself in the first or the second position when a mass above a predetermined threshold is in place in the container. When the container is occupying the second position, it passes, under the effect of gravity, from the second position into the first position when the mass is no longer in place in the container.

The invention relates to the packaging and transportation of biopharmaceutical fluids. The invention more specifically relates to containers for flexible bags intended to contain a biopharmaceutical fluid.

By “biopharmaceutical fluid”, this means a fluid coming from biotechnology, for example a culture medium, a cell culture, a buffer solution, an artificial nutrition liquid, a blood fraction, a derivative of blood products or a pharmaceutical fluid, or more generally a fluid intended to be used in the medical field.

Historically, the biopharmaceutical fluid is in place in a reusable stainless-steel container. Thus, it was necessary to sterilize the container between two operations, which was complex, expensive and risky, in the case where the sterilization was imperfect.

That is why, usually, the biopharmaceutical fluid is in place in a flexible bag. The flexible bag has the advantage of occupying a minimum volume when it does not contain biopharmaceutical fluid. In this case, it is folded and occupies a low volume. Conversely, when it contains the biopharmaceutical fluid, it occupies a slightly higher volume. Furthermore, as it is flexible, it can withstand small elastic deformations without being pierced. Thus, the risk of leakage is reduced. The flexible bag is generally single-use, it is thrown away after having been used. Furthermore, the flexible bag is sized to be able to contain a set biopharmaceutical fluid volume, which can go from 1 liter to 500 liters.

Thus, for example, to transport the flexible bag, filled with biopharmaceutical fluid, in particular by road, by train or by air, it is in place in a rigid container which forms a protection for the flexible bag. The flexible bag is generally in place in the container from the filling thereof with biopharmaceutical fluid until it is emptied.

However, the rigid container comprises a general parallelepipedal shape. Thus, access to the flexible bag is difficult. In particular, the emptying of the flexible bag is a difficult operation, when it is in place in the container. In this case, an operator wishing to empty the flexible bag must necessarily remove the flexible bag from the container. This handling is difficult, as the flexible bag thus risks being pierced.

An aim of the invention is to provide a container of which the handling is simpler.

To do this, a container for flexible bag is provided according to the invention, intended to contain a biopharmaceutical fluid, comprising, in reference to a vertical direction, a lower wall, two lateral walls extending from the lower wall and at least one transfer wall making an obtuse angle with the lower wall, such that the container is able to occupy a first stable equilibrium position and a second position in which the transfer wall makes a right angle with the vertical direction, the container is configured to pass from the first position to the second position, and vice versa, by rotating about an edge corner connecting the lower wall and the transfer wall, the container is able to hold itself in the first or the second position when a mass above a predetermined threshold is in place in the container, the lower wall and the transfer wall have dimensions such that, when the container occupies the second position, it is able to pass, under the effect of gravity, from the second position to the first position when the mass is no longer in place in the container.

Thus, when the container comprises the mass above the predetermined threshold, the system formed by the container and the mass comprises two equilibrium positions. The mass can, for example, be presented in the form of a flexible bag containing the biopharmaceutical fluid. An operator can therefore install the container in either of the position, according to what is desired to be done. The container must no longer necessarily be sized according to one single equilibrium position, that it is able to occupy when it comprises the flexible bag. The dimensions of the container can be best adapted, depending on the function that it fulfils when it occupies either of the equilibrium positions.

Preferably, the first position is a storage position, in which the fluid which leaks from the flexible bag is stored in the container, when the flexible bag is present. The first position can therefore be that used during transportation. In this scenario, when the container undergoes a movement and slightly changes position, it naturally returns to the stable equilibrium position. The transportation of the biopharmaceutical fluid is therefore safer. Furthermore, in case of leakage, the biopharmaceutical fluid remains confined in the container and does not leak. The risk of contaminating nearby containers is therefore reduced.

Advantageously, the second position is an emptying position in which the fluid removed from the flexible bag flows outside of the container, when the flexible bag is present.

Thus, the second position is such that the biopharmaceutical fluid removed from the flexible bag flows naturally outside of the container. The emptying of the container is therefore simpler. Furthermore, when the emptying has ended, and when the biopharmaceutical fluid no longer exerts the weight thereof in the container, the latter regains the first equilibrium position without the operator intervening. The handling of the container is therefore simplified. Moreover, one or more pipes can be in place, being used for the emptying and/or the filling of the flexible bag, in the container so as to constrain the position occupied by the container during filling and emptying operations.

According to an embodiment, the two lateral walls extend from the transfer wall.

The container is therefore simple to produce.

Preferably, the container comprises a removable cover being supported on the lateral walls and the transfer wall, so as to close the container.

The flexible bag is thus better protected.

Advantageously, the cover comprises a seal on a portion of the peripheral perimeter thereof, preferably over all of the peripheral perimeter thereof.

The risk of leakage is therefore all the more reduced.

According to an embodiment, at least one from among the lower wall, the lateral walls and the transfer wall, is flat.

Preferably, at least one of the two lateral walls forms a right angle with the lower wall.

The production of the container is thus simpler.

Advantageously, at least one of the lateral walls comprises a handle.

Preferably, the handle is formed by a recess.

The handling of the container is therefore easier.

According to an embodiment, the container comprises a partition wall, situated facing the transfer wall, advantageously flat, and preferably making an obtuse angle with the lower wall.

The flexible bag is thus better protected.

Preferably, the container comprises at least one removable containment wall suitable for being applied on an upper face of the flexible bag, when the flexible bag is present.

The containment wall makes it possible to restrain the shape of the flexible bag, which can prove to be useful, in particular during the transportation of several flexible bags simultaneously.

Advantageously, the container comprises a longitudinal direction and a transverse direction, at least one lateral wall comprises two offset parts, along the transverse direction, such that an outer surface of the wall delimits a housing which makes it possible for the insertion of the container in another container.

The stacking of several containers, not comprising flexible bags, occupies therefore less space.

According to an embodiment, the lateral wall comprises a bearing surface, extending into a horizontal plane, which contributes to delimiting the housing.

The bearing surface makes it possible to easily stack the containers when they comprise flexible bags.

An assembly comprising a first and a second container is also provided, according to the invention, such as described above, in which the outer surface of the two lateral walls of the first container is, at least partially in contact with the inner surface of the two lateral walls of the second container, such that the first container is stacked on the second container.

Here, this is a preferable arrangement, as storing containers does not occupy very much space.

Finally, according to the invention, a container such as described above, and a flexible bag intended to contain a biopharmaceutical fluid are provided.

Moreover, according to the invention, a container for flexible bag intended to contain a biopharmaceutical fluid is provided, comprising, in reference to a vertical direction (Y), a lower wall, two lateral walls extending from the lower wall and at least one transfer wall making an obtuse angle with the lower wall, such that the container is able to occupy a first stable equilibrium position and a second stable equilibrium position in which the transfer wall makes a right angle with the vertical direction (Y), the container is configured to pass from the first position to the second position, and vice versa, by rotating about an edge corner connecting the lower wall and the transfer wall, the lower wall and the transfer wall have dimensions such that, when the container occupies the first position, it is able to pass, under the effect of a mass above a first predetermined threshold in place on a free edge corner of the transfer wall, to the second position and when the container occupies the second position, it is able to pass, under the effect of a mass above a second predetermined threshold in place on the lower wall, to the first position.

Thus, during emptying, the container passes from the first to the second position under the effect of a pipe in place on the free edge corner of the transfer wall. Conversely, during filling, the container is initially in second position. When the mass of the flexible bag filled with liquid exceeds the second predetermined threshold, it generates the tilting of the container, from the second to the first position. Thus, the first and second positions are stable equilibrium position, and it is the interaction of the container with the flexible bag and the pipe which generates the movement thereof from one to the other of the positions.

It will be noted, moreover, that all the additional characteristics mentioned above can be associated with the container which comprises two stable equilibrium positions.

As non-limiting examples, three embodiments of the invention using the following figures will now be described:

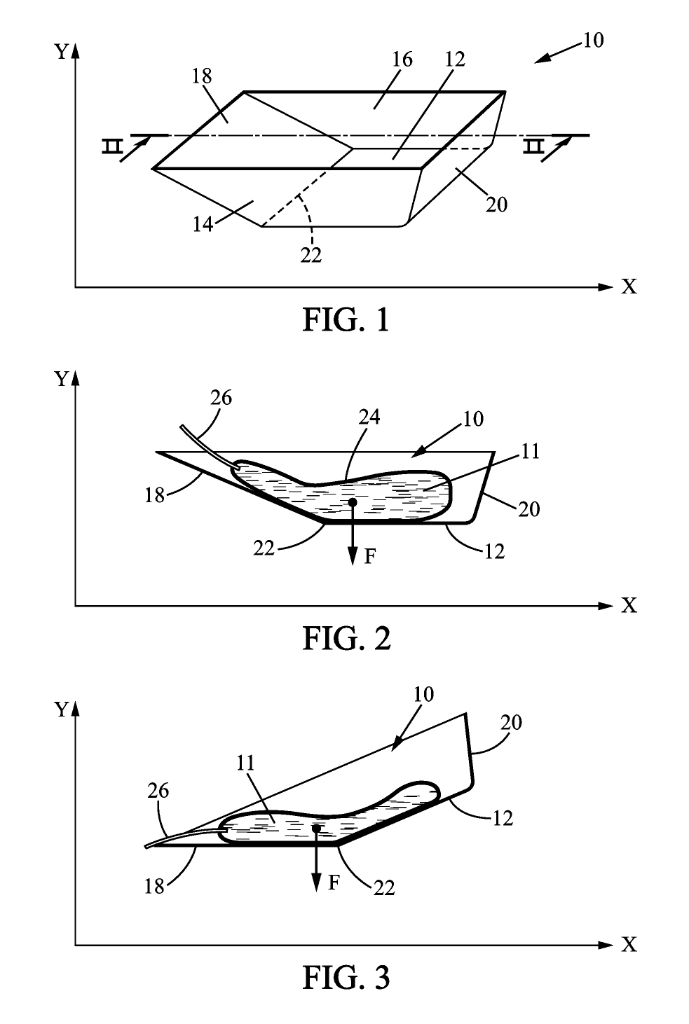

FIG. 1 is a perspective view of a container according to the invention,

FIGS. 2 and 3 are cross-sectional views, along the line II-II of FIG. 1, of the container in which a flexible bag is in place,

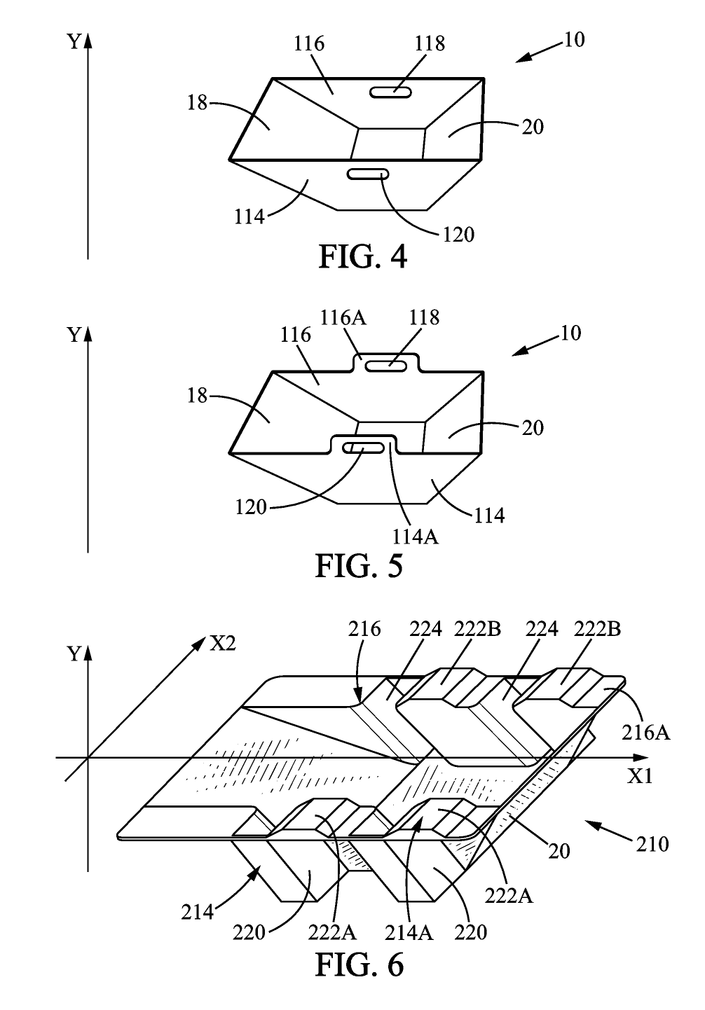

FIGS. 4 and 5 are perspective views of a container, respectively according to a second embodiment of the invention and according to a variant of this embodiment,

FIG. 6 is a perspective view of a container according to a third embodiment of the invention, and

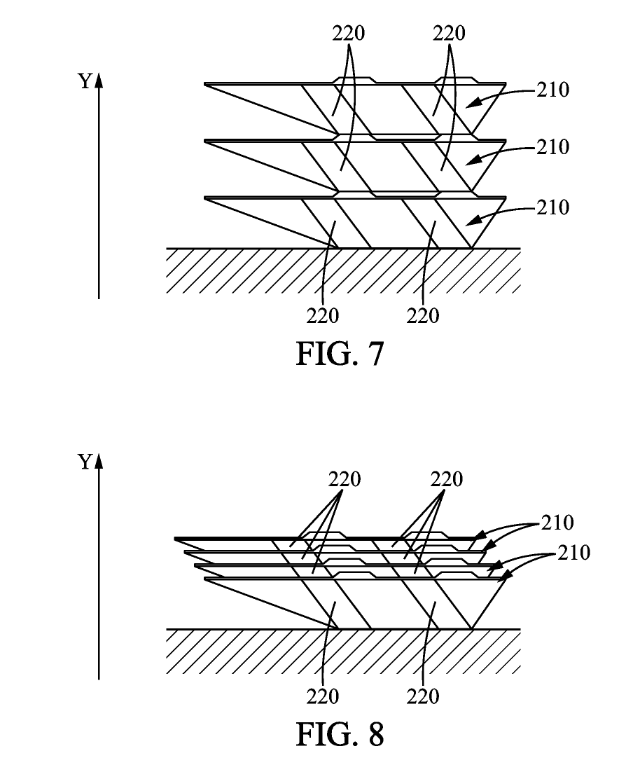

FIGS. 7 and 8 are front views of three containers according to the third embodiment of the invention.

It will be noted, that in all the figures, the container(s) is/are placed on a horizontal support.

A container 10 for a flexible bag 11 has been represented in FIG. 1, represented in FIGS. 2 and 3, intended to contain a biopharmaceutical fluid, according to an embodiment of the invention.

In reference to a vertical direction (Y), the container 10 comprises a lower wall 12, which forms the bottom of the container 10, two lateral walls 14, 16, a transfer wall 18 and a partition wall 20. The transfer wall 18 and the partition wall 20, of which the functions are described below, in particular contribute to delimiting the container 10.

The inner surfaces of the walls 12, 14, 16, 18, 20 indeed delimit a space to receive the flexible bag 11. The inner surfaces of the transfer 18 and partition 20 walls are opposite. The inner surfaces of the lateral walls 14, 16 are also opposite.

The two lateral walls 14, 16 extend from the lower wall 12 and from the transfer wall 18. Furthermore, the lateral walls 14, 16 make a right angle with the lower wall 12. However, the transfer wall 18 is directly connected to the lower wall 12 and makes with it, a strictly obtuse angle. This means that the value of this angle is strictly greater than 90° and strictly less than 180°. Preferably, the angle is between 135° and 150°. The transfer wall 18 and the lower wall 12 comprise a common edge corner 22 which connects them. To the left of the edge corner 22, the transfer wall 18 extends and to the right of the edge corner 22, the lower wall 12 extends.

Furthermore, the partition wall 20 makes an obtuse angle with the lower wall 12. This angle is less obtuse than that formed between the lower wall 12 and the transfer wall 18. In addition, as can be seen in FIG. 1, the lower wall 12, the two lateral walls 14, 16, the transfer wall 18 and the partition wall 20 are flat. Optionally, at least one of the walls 12, 14, 16, 18, 20 is flat.

Furthermore, the bottom wall 12 makes a zero angle with a horizontal direction (X).

The upper edge, in reference to the vertical direction (Y), the walls 12, 14, 16, 18, 20 is regular and reaches the same height. The container 10 comprises therefore an upper regular edge. According to a variant of the present embodiment, the container 10 comprises a removable cover which bears against the lateral walls 14, 16, the transfer wall 18 and the partition wall 20 so as to close the container 10. Preferably, the cover thus comprises a seal on a portion of the peripheral perimeter thereof, and advantageously over all of the peripheral perimeter thereof to close the container 10 in a sealed manner. In a variant, the seal is in place on the upper edge of the transfer wall 18, of the partition wall 20 and of the lateral walls 14, 16.

According to another variant, the container 10 comprises a removable containment wall suitable for being applied on an upper face of the flexible bag 11. In this manner, the shape of it is restrained to limit the volume that it occupies. The containment wall is thus mobile in the vertical direction (Y). This containment wall is therefore not intended to ensure sealing between the inside and the outside of the container 10. The cover and the removable containment wall can therefore advantageously be connected.

The lower wall 12 and the transfer wall 18 have suitable dimensions, given the dimensions of the lateral walls 14, 16 and of the partition wall 20, such that the position illustrated in FIG. 1 is a stable equilibrium position when the container 10 does not comprise the flexible bag 11. Thus, the container 10 by itself is able to occupy a first equilibrium position and this equilibrium position is stable.

The container 10 and the flexible bag 11 have been represented in FIGS. 2 and 3. The flexible bag 11 comprises a main flexible part 24, which contains the biopharmaceutical fluid, and a pipe 26 which puts the inside and outside of the main part 24 of the flexible bag 11 in fluid communication.

In FIGS. 2 and 3, the weight exerted by the flexible bag 11 has been represented by an arrow F. It is therefore the point of applying weight.

When the container 10 is in the position illustrated in FIGS. 1 and 2, the transfer wall 18 forms a ramp, for the biopharmaceutical fluid contained by the flexible bag 11, which tends to concentrate the biopharmaceutical fluid in the portion of the main part 24 of the flexible bag 11 which is in the proximity of the partition wall 20. This is due to the fact that the lower wall 12 makes a zero angle with the horizontal direction (X) while the transfer wall 18 makes an acute, non-zero angle with the horizontal direction (X). Thus, the center of gravity of the flexible bag is situated to the right of the edge corner 22 and the weight F of the flexible bag 11 is normal at a surface formed by the lower wall 12. Thus, the weight F of the flexible bag 11 holds the container in the position illustrated in FIG. 2, which is the first stable equilibrium position of the container 10. Optionally, in the container 10, holding means which are opposite the sliding of the flexible bag 11 can be in place. Otherwise, the friction due to the weight of the flexible bag 11 suffices.

During the transportation of the flexible bag 11 in the container 10 in particular, the use of holding means is useful for holding the flexible bag 11 in a position where the center of gravity thereof is situated to the right of the edge corner 22 and prevent small mechanical disturbances, such as vibrations for example, make the center of gravity of the flexible bag 11 tilt to the left of the edge corner 22.

This first position is a position for storing the flexible bag 11. Indeed, in this position, where the main part 24 of the flexible bag 11 is wholly in place in the space defined by the walls 12, 14, 16, 18, 20, of the biopharmaceutical fluid which leaks from the flexible bag 11 is stored in the container 10. Thus, this first position is suitable for the transportation of the flexible bag 11.

When an operator makes the container tilt in a position illustrated in FIG. 3, the biopharmaceutical fluid contained by the flexible bag 11 will naturally be positioned, under the effect of gravity, in a portion of the main part 24 of the flexible bag 11 which is in direct contact with the transfer wall 18. In this scenario, it is the lower wall 12, which makes an acute non-zero angle with the horizontal direction (X) and the transfer wall 18 which makes a zero angle with the horizontal direction (X). Thus, it is the lower wall 12 which makes a ramp for the biopharmaceutical fluid.

The center of gravity of the flexible bag is therefore situated to the left of the edge corner 22 and the weight F of the flexible bag 11 makes a right angle with the transfer wall 18. Thus, the weight F of the flexible bag 11 holds the container in the position illustrated in FIG. 3 which is a second equilibrium position of the container 10. Thus, the position illustrated in FIG. 3 is a stable equilibrium position for a system formed by the container 10 and the flexible bag 11 containing the biopharmaceutical fluid. As indicated above, it is possible to put in place the means for holding the flexible bag 11 in the position where the center of gravity of the flexible bag 11 is in place to the right of the edge corner 22.

In this second position of the container 10, the biopharmaceutical fluid removed from the flexible bag 10, that it comes from a leakage from the main part 24 or from the pipe 26, flows outside of the container 10. This is due to the fact that the transfer wall 18 makes a zero angle with the horizontal direction (X), and therefore a right angle with the vertical direction (Y) and comprises a free edge contrary to the lower wall 12. That is why, this second equilibrium position is a preferable position for emptying the container 10.

As can be seen by comparing FIGS. 2 and 3, the container 10 is able to pass from the first equilibrium position illustrated in FIG. 2, to the second position illustrated in FIG. 3, and vice versa, by rotating about the edge corner 22 which connects the lower wall 12 and the transfer wall 18. Thus, the operator does not need to exert a force that is too high to make the container 10 pass from an equilibrium position to the other. It must simply exert a pressure on the free edge of the transfer wall 18. The distance between this free edge and the edge corner 22 makes it possible to limit the forces required.

Furthermore, in reference to FIG. 3, when the biopharmaceutical fluid is wholly removed from the flexible bag 11, the weight of the latter does not, just by itself, hold the container 10 in the second position illustrated in FIG. 3. The container 10 therefore gains the first stable equilibrium position, illustrated in FIG. 2. As explained above, this is due, in particular to the dimensions of the lower wall 12 and the transfer wall 18. The position illustrated in FIG. 3 is therefore not an equilibrium position for the container 10 when it does not comprise a mass which is above a predetermined threshold.

More generally, the container 10 is able to hold itself in the first or the second position when a mass exceeding a predetermined threshold is in place in the container 10. When it occupies the second position, it is able to pass, under the effect of gravity, from the second position to the first position as soon as the mass is no longer in place in the container 10.

Synthetically, the position illustrated in FIG. 2 is a stable equilibrium position for the container 10, whether this comprises the flexible bag 11 or not, and whether this contains the biopharmaceutical fluid or not. The position illustrated in FIG. 3 is a stable equilibrium position when the container 10 comprises the flexible bag 11 and whether this contains the biopharmaceutical fluid.

A method for filling the flexible bag 11 will now be described, when it is positioned in the container 10.

Initially, the container 10 occupies the first position and the flexible bag 11 is empty. The pipe 26 is connected to a first end of a filling tube. Another end of the filling tube is, for example, connected to a reservoir comprising liquid intended to fill the flexible bag 11. The pipe 26 thus rests cantilevered on a free edge corner of the transfer wall 18. However, the weight of the pipe 26 is not sufficient to make the container 10 pass from the first to the second position.

It is started by filling the flexible bag 11 until the latter is filled. The container 10 has occupied the first position during all the filling.

An alternative method for filling the container will now be described.

Initially, the container 10 occupies the first position. The pipe 26 is connected to the first end of the filling tube. The container 10 is tilted in the second position. The weight of the pipe 26, which rests on the free edge corner of the transfer wall 18, is sufficient to ensure the stability of the second position.

Then, the flexible bag 11 is started to be filled. When the flexible bag 11 is sufficiently filled and exerts a sufficient weight to counteract the impact of the weight of the pipe 26, the container 10 regains the first position.

Once the flexible bag 11 is sufficiently filled, the pipe 26 is disconnected and the filling pipe. The container 10 occupies the first position.

By adapting the dimensions of the transfer wall 18 and the lower wall 12, the filling level can be predetermined, and therefore a predetermined threshold of the mass, which leads to the tilting of the container 10 from the second position, illustrated in FIG. 3, to the first position, illustrated in FIG. 2. For example, the abovementioned elements can be sized such that the tilting from the first to the second position takes place when the flexible bag is half solid, i.e. that the biopharmaceutical fluid occupies a volume equal to half of the maximum capacity of the flexible bag 11.

A method for emptying the flexible bag 11 in the container 10 will now be described.

Initially, as illustrated in FIG. 2, the container 10 comprises the filled flexible bag 11. The operator thus takes the pipe 26 and connects it to a first end of a pipe, called emptying pipe. The pipe 26 thus rests on a free edge corner of the transfer wall 18. A second end of the emptying pipe is itself connected to a container intended to receive the liquid removed from the flexible bag 11. Possibly, the emptying pipe is also connected to a pump.

Then, the operator makes the container 10 pass from the first to the second position and opens the pipe 26 to put fluid through inside and outside of the flexible bag 11. Thus, the liquid contained in the flexible bag 11 gains the pipe 26, the emptying pipe and joins to the container. It will be noted that because of the movement of the liquid, the container 10 thus occupies the second position which is a stable equilibrium position as indicated above.

When emptying has ended, the pipe 26 which rests cantilevered on the transfer wall 18, exerts a sufficient force to hold the container 10 in the second position, illustrated in FIG. 3.

Then, the pipe 26 is disconnected from the first end of the emptying pipe.

Then, the pipe 26 is retracted such that it does not extend beyond a space formed by the walls 12, 14, 16, 18 and 20 of the container 10. Thus, the weight of the flexible bag 11, empty, is no longer sufficient to hold the container 10 in the position illustrated in FIG. 3, the container 10 regains the first position.

Likewise, if after disconnection of the pipe 26 from the first end of the emptying pipe, the flexible bag 11 and the pipe 26 are removed, the container 10 regains the first position under the action of the container 10, because of the position of the center of gravity of the container 10.

An alternative method for emptying the container will now be described.

Initially, the container 10 occupies the first position. The pipe 26 is connected to the emptying pipe such that the pipe 26 rests on the free edge corner of the transfer wall 18. In this configuration, the weight of the pipe 26 is not sufficient to make the container pass into the second position, in particular because of the weight of the flexible bag 11 containing the liquid.

Then, the emptying is started. When the emptying is advanced to a stage where the weight of the flexible bag 11 is no longer sufficient to hold the container 10 in the position illustrated in FIG. 2, the container 10 gains the second position, in particular under the action of the weight of the pipe 26. It will also be noted that the movement of the liquid which leaves the flexible bag 11 to gain the container contributes to the change of position of the container 10.

Then, the pipe 26 and the emptying pipe are disconnected. As indicated above, the container 10 regains the first position, either as the pipe 26 is retracted to no longer rest on the free edge corner of the transfer wall 18, or as the empty flexible bag 11 and the pipe 26 have been removed from the container 10.

Moreover, it will be noted that by adapting the dimensions of the transfer wall 18 and of the lower wall 12, as well as the mass of the pipe 26, the emptying level can be predetermined, and therefore the predetermined threshold of the mass, which generates the tilting of the container 10 from the first position, illustrated in FIG. 2, to the second position, illustrated in FIG. 3. For example, the abovementioned elements can be sized such that the tilting from the second to the first position takes place when the flexible bag is half empty, i.e. that the biopharmaceutical fluid occupies a volume equal to half the maximum capacity of the flexible bag 11.

A second embodiment of the invention will not be described, in reference to FIGS. 4 and 5. Only the differences with the first embodiment will be explained. The numerical references of identical elements are conserved.

The two lateral walls 114, 116 of the container 110, according to the second embodiment, each having a recess 118, 120 which offer a function of gripping the container 110. The recesses 118, 120 are situated opposite one another. They are situated in the proximity of the upper free edges, along the vertical direction (Y), of the lateral walls 114, 116. They have dimensions suitable such that the operator can take them by hand. When the container 110 is sized to receive a flexible bag of relatively significant volume, for example 100 liters, the recesses 118, 120 can be sized to be complementary to mechanized gripping means. More generally, the lateral walls 114, 116 of the container 110 can comprise a handle which can be formed from a boss, for example.

In FIG. 5, a variant of the present embodiment has been represented. Here, the lateral walls 114, 116 each comprise, on the upper free edges thereof, a surplus of material in the vertical direction (Y) respectively 114A, 116A, which extends along the vertical direction (Y). These surpluses of material 114A, 116A are situated opposite one another. They can respectively support a recess 118, 120. The surpluses of material 114A, 116A, are positioned equally from the upper free edges of the transfer walls 18 and partition walls 20. The recesses 118, 120 here also form handles of the container 110.

In FIGS. 6 to 8, a container 210 according to a third embodiment of the invention has been represented. Only the differences with the first embodiment will be explained. The numerical references of identical elements are conserved.

In a horizontal plane, the container 210 comprises a longitudinal direction (X1) and a transverse direction (X2). Each lateral wall 214, 216 comprises, along the longitudinal direction X1, a rim 214A, 216A which extends in the horizontal plane. These rims 214A, 216A are situated respectively at an end along the vertical direction (Y), the lateral walls 214, 216.

Furthermore, the lateral walls 214, 216 are not flat. Indeed, the wall 214 comprises two offset parts 220, along the transverse direction (X2), successively in place along the longitudinal direction (X1). Likewise, the wall 216 comprises two offset parts 225, along the transverse direction (X2), successively in place along the longitudinal direction (X1). Along the vertical direction (Y), the offset parts 220, 224 extend angled.

In this manner, an inner surface of the lateral walls 214, 216 defines an inner housing which makes it possible for the insertion of another container 210 in the container 210 as illustrated in FIG. 8. Likewise, an outer surface of the lateral walls 214, 216 defines an outer housing which makes it possible for the insertion of the container 210 in another container 210 illustrated in FIG. 8. Indeed, in this figure, it is observed that the outer surfaces of the offset parts 220, 224 of the lateral walls 214, 216 of a first container 210 mold the inner surfaces of the offset parts 220, 224 of the lateral walls of a second container 210 situated under the first container 210.

Thus, as can be seen in FIG. 8, four containers 210 can, for example, be stacked by decreasing the volume in the vertical direction (Y).

More generally, this FIG. 8 illustrates that when at least one first and one second container 210 is stacked on one another, an outer surface of the two lateral walls 214, 216 of the first container 210 is, at least partially, in contact with an inner surface of the two lateral walls 214, 216 of the second container 210 such that the first container 210 is stacked on the second container 210.

In addition, the rims 214A, 216A, each comprise two bearing surfaces 222A, 222B, extending in the horizontal plane, which contribute to delimiting the housing making it possible for the insertion of the container 210 in another container 210. These bearing surfaces 222A, 222B are in place in the proximity of the offset parts 220, 224, along the longitudinal direction (X1). Furthermore, the bearing surfaces 222A, 222B of a first container 210 make it possible to stack a second container 210 on the first container 210 with no insertion of the second container 210 in the first container 210 as illustrated in FIG. 7. Thus, the containers 210 can be stacked when, for example, they each comprise a flexible bag 11.

Of course, numerous variants can be brought to the invention without moving away from the scope thereof.

The shapes of the housing which makes it possible for the insertion of a container 210 in another container 210, can for example be varied.

All types of materials can be used to produce the container 10, 110 or 210. This can be formed by means of an injection-molding method and comprises therefore mainly a polymer material. It can also be formed by means of a stamping method. In this case, it mainly comprises a metal material.

The shape of the lateral walls 214, 216 of the container 210 can also be varied, such that the inner or outer surfaces of these delimit the housing which makes it possible, either to receive another container 210, or to introduce the container 210 in another container.

Moreover, according to a variant of the invention, it is also possible to size the lower walls 12, lateral walls 14, 16, transfer walls 18 and partition walls 20, such that the container 10 comprises two stable equilibrium positions. The first stable equilibrium position is that illustrated in FIG. 2 and the second stable equilibrium position is that illustrated in FIG. 3.

A method for filling the container 10 which comprises the two stable equilibrium positions will now be described.

Initially, the container 10 occupies the second stable position. The bag is placed in the container 10 and the pipe 26 is connected to the first end of the filling tube.

Then, the flexible bag 11 is started to be filled. By adapting the dimensions of the transfer wall 18 and of the lower wall 12, the filling level can be predetermined, and therefore a predetermined threshold of the mass, in place on the lower wall 12 of the container 10, which generates the tilting of the container 10 from the second position, illustrated in FIG. 3, to the first position, illustrated in FIG. 2. For example, the abovementioned elements can be sized, such that the tilting from the first to the second position takes place when the flexible bag is half solid, i.e. that the biopharmaceutical fluid occupies a volume equal to half the maximum capacity of the flexible bag 11.

A method for emptying the flexible bag 11 in the container 10 comprising two stable equilibrium positions will now be described.

Initially, as illustrated in FIG. 2, the container 10 comprises the filled flexible bag 11. The operator thus takes the pipe 26 and connects it to a first end of a pipe, called emptying pipe. The pipe 28 thus rests on a free edge corner of the transfer wall 18. A second end of the emptying pipe is itself connected to a container intended to receive the liquid removed from the flexible bag 11. Possibly, the emptying pipe is also connected to a pump.

Then, the operator makes the container 10 pass from the first to the second position and opens the pipe 26 to put fluid through inside and outside of the flexible bag 11. Thus, the liquid contained in the flexible bag 11 gains the pipe 26, the emptying pipe and joins to the container. It will be noted that because of the movement of the liquid, the container 10 thus occupies the second position which is a stable equilibrium position as indicated above.

When emptying has ended, the pipe 26 is disconnected from the first end of the emptying pipe.

Then, the pipe 26 is retracted such that it does not extend beyond a space formed by the walls 12, 14, 16, 18 and 20 of the container 10. The container 10 continues to occupy the second stable equilibrium position. Likewise, if after disconnection of the pipe 26 from the first end of the emptying pipe, the flexible bag 11 and the pipe 26 are removed, the container 10 continues to occupy the second stable equilibrium position. An alternative method for emptying the container will now be described.

Initially, the container 10 occupies the first position. The pipe 26 is connected to the emptying pipe such that the pipe 26 rests on the free edge corner of the transfer wall 18. In this configuration, the weight of the pipe 26 is not sufficient to make the container pass into the second position, in particular because of the weight of the flexible bag 11 containing the liquid.

Then, the emptying is started. When the emptying is advanced to a stage where the weight of the flexible bag 11 is no longer sufficient to hold the container 10 in the position illustrated in FIG. 2, the container 10 gains the second position, in particular under the action of the weight of the pipe 26. It will also be noted that the movement of the liquid which leaves the flexible bag 11 to gain the container contributes to the change of position of the container 10.

Then, the pipe 26 and the emptying pipe are disconnected. Likewise, if after disconnection of the pipe 26 from the first end of the emptying pipe, the flexible bag 11 and the pipe 26 are removed, the container 10 continues to occupy the second stable equilibrium position.

Moreover, it will be noted that by adapting the dimensions of the transfer wall 18 and of the lower wall 12, as well as the mass of the pipe 26, the emptying level can be predetermined, and therefore the predetermined threshold of the mass, which generates the tilting of the container 10 from the first position, illustrated in FIG. 2, to the second position, illustrated in FIG. 3. For example, the abovementioned elements can be sized such that the tilting from the second to the first position takes place when the flexible bag is half empty, i.e. that the biopharmaceutical fluid occupies a volume equal to half the maximum capacity of the flexible bag 11.

1. Container for flexible bag intended to contain a biopharmaceutical fluid, comprising, in reference to a vertical direction, a lower wall, two lateral walls extending from the lower wall and at least one transfer wall making an obtuse angle with the lower wall, such that the container is able to occupy a first stable equilibrium position and a second position in which the transfer wall makes a right angle with the vertical direction, the container is configured to pass from the first position to the second position, and vice versa, by rotating about an edge corner connecting the lower wall and the transfer wall, the container is able to hold itself in the first or the second position when a mass above a predetermined threshold is in place in the container, the lower wall and the transfer wall have dimensions such that, when the container occupies the second position, it is able to pass, under the effect of gravity, from the second position to the first position when the mass is no longer in place in the container.

2. Container according to claim 1, in which the first position is a storage position in which the fluid which leaks from the flexible bag is stored in the container, when the flexible bag is present.

3. Container according to claim 1, in which the second position is an emptying position in which the fluid removed from the flexible bag flows outside of the container, when the flexible bag is present.

4. Container according to claim 1, further comprising a removable cover bearing against the lateral walls and the transfer wall so as to close the container.

5. Container according to claim 4, in which the cover comprises a seal on a portion of the peripheral perimeter thereof.

6. Container according to claim 1, in which at least one from among the lower wall, the lateral walls and the transfer wall is flat.

7. Container according to claim 1, in which at least one of the lateral walls comprises a handle.

8. Container according to claim 7, in which the handle is formed by a recess.

9. Container according to claim 1, further comprising a partition wall, situated opposite the transfer wall advantageously flat and making an obtuse angle with the lower wall.

10. Container according to claim 1, further comprising at least one removable containment wall suitable for being applied on an upper face of the flexible bag, when the flexible bag is present.

11. Container according to claim 1, further comprising a longitudinal direction and a transverse direction and wherein at least one lateral wall comprises two offset parts, along the transverse direction, such that an outer surface of the wall delimits a housing which makes it possible for the insertion of the container in another container.

12. Container according to claim 11, in which the lateral wall comprises a bearing surface extending in a horizontal plane, which contributes to delimiting the housing.

13. Container for flexible bag intended to contain a biopharmaceutical fluid, further comprising, in reference to a vertical direction, a lower wall, two lateral walls extending from the lower wall and at least one transfer wall making an obtuse angle with the lower wall, such that the container is able to occupy a first stable equilibrium position and a second stable equilibrium position in which the transfer wall makes a right angle with the vertical direction, the container being configured to pass from the first position to the second position, and vice versa, by rotating about an edge corner connecting the lower wall and the transfer wall, the lower wall and the transfer wall having dimensions such that, when the container occupies the first position, it is able to pass, under the effect of a mass above a first predetermined threshold in place on a free edge corner of the transfer wall, to the second position and when the container occupies the second position, it is able to pass, under the effect of a mass above a second predetermined threshold in place on the lower wall, to the first position.

14. Assembly comprising a first and a second container according to claim 11, in which the outer surface of the two lateral walls of the first container is, at least partially in contact with the inner surface of the two lateral walls of the second container, such that the first container is stacked on the second container.

15. Assembly comprising a container according to claim 1 and a flexible bag intended to contain a biopharmaceutical fluid.

16. The container of claim 5 wherein the portion of the peripheral perimeter comprises all the peripheral perimeter.
